(19) United States
(12) Patent Application Publication
(10) Pub. No.: US 2019/0361987 A1
(43) Pub. Date: Nov. 28, 2019

(54) APPARATUS, SYSTEM AND METHOD FOR ANALYZING REVIEW CONTENT

(71) Applicant: eBay Inc., San Jose, CA (US)

(72) Inventors: Qifeng Qiao, Milpitas, CA (US); Nish Parikh, Fremont, CA (US); Saratchandra Indrakanti, Sunnyvale, CA (US); Gyanit Singh, Fremont, CA (US); Justin Nicholas House, San Jose, CA (US)

(21) Appl. No.: 15/987,158

(22) Filed: May 23, 2018

(51) Int. Cl. G06F 17/30

(52) U.S. Cl. CPC G06F 17/3069; G06F 17/30867; G06F 17/30696

(57) ABSTRACT

Method for analyzing review content is described herein. The method starts by generating a helpfulness score for each review in the plurality of reviews. A first set of reviews is selected based on the helpfulness scores for each review in the plurality of review and a helpfulness score for each sentence in each review in the first set of reviews is generated. The review summary is then generated by selecting sentences in each review in the first set of reviews based on the helpfulness score of each sentence. The review summary includes the selected sentences. Other embodiments are also described.

### TECHNICAL FIELD

The present application relates generally to apparatuses, systems and methods of analyzing review content to generate a review summary or a blurb related to an item that may be a product or service. More specifically, the review summary combines sentences from a number of reviews of an item and selects the sentences for the review summary based on at least one of: helpfulness scores on a sentence level, probability of addressing relevant topics, the source of each sentence, the sentiment of the sentences, as well as quality of the sentences in the reviews. Similarly, the blurb may be an excerpt of one of the sentences from the number of reviews of the item that expresses an opinion on an aspect of the item.

### BACKGROUND

Product and service reviews are an important aspect of commerce for businesses and consumers. Users often search for and read reviews regarding various items (e.g., products, services, etc.). Users often rely on the reviews to help make buying decisions.

However, the large number of reviews that are available for each item make it difficult for users to locate the more relevant information and key opinions. Many of the reviews may also be unnecessarily long, redundant, poorly written, etc. Thus, users may greatly benefit from being provided with improved access to the key points in the reviews to help inform their purchases.

### BRIEF DESCRIPTION OF THE DRAWINGS

Some embodiments are illustrated by way of example and not limitation in the figures of the accompanying drawings, in which:

FIG. 1 is a block diagram of an example system for analyzing review content, in accordance with an example embodiment;

FIG. 2 is a block diagram of an example apparatus for analyzing review content, in accordance with an example embodiment;

FIG. 3 is a flowchart of an example method for analyzing review content to generate a review summary, in accordance with one embodiment;

FIG. 4 is a flowchart for an example method of generating the review summary from FIG. 3, in accordance with one embodiment;

FIG. 5 illustrates an example user interface displaying reviews associated with a type of item, in accordance with an example embodiment;

FIG. 6 illustrates an example user interface displaying reviews associated with one of the items, in accordance with an example embodiment;

FIG. 7 illustrates an example user interface displaying the review summary associated with the item, in accordance with an example embodiment;

FIG. 8 is a flowchart of an example method for analyzing review content to generate a blurb, in accordance with one embodiment;

FIG. 9 illustrates an example user interface displaying the blurbs associated with the items, in accordance with an example embodiment;

FIG. 9 is a block diagram illustrating an example mobile device, according to an example embodiment; and

FIG. 10 is a block diagram of a machine within which instructions may be executed for causing the machine to perform any one or more of the methodologies discussed herein.

### DETAILED DESCRIPTION

In the following detailed description of example embodiments of the invention, reference is made to specific examples by way of drawings and illustrations. These examples are described in sufficient detail to enable those skilled in the art to practice the invention and serve to illustrate how the invention may be applied to various purposes or embodiments. Other example embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, apparatus, and systems for analyzing review content are disclosed. The review content includes reviews of items, which may be, for example, products, services, etc. The method may be implemented as a machine learning method and may summarize reviews based on a variety of decision factors, such as a review helpfulness score, the content of the review, the sentiment expressed in the review, and the like.

In one example embodiment, the helpfulness of a review is evaluated at the document level (where a document may comprise multiple reviews), the review level, the sentence level, or any combination thereof. In general, each review may be treated as a group of sentences where one or more of the sentences may be extracted for insertion into a review summary. The review helpfulness measure may be provided by readers of the review, by a quality analysis of the review, or both. In one example embodiment, a multi-instance machine-learning algorithm may be applied to determine a helpfulness score at the sentence level.

Initially, the reviews that have the largest helpfulness scores (i.e., the reviews that are determined to be most helpful) are selected as candidates for summarization. A modeling algorithm, such as a bootstrap topic-modeling algorithm, may be used to learn a unique set of semantic topics for each product or service, and the probability of a review matching one of the topics is estimated.

A set of reviews is then formed as an extraction pool based on the probability that a review is helpful and the probability that a review represents a particular topic(s). Finally, a ranking algorithm is applied to extract sentences from the pool of reviews based on sentence quality, sentence sentiment, helpfulness scores (such as sentence and review helpfulness scores), and the like.

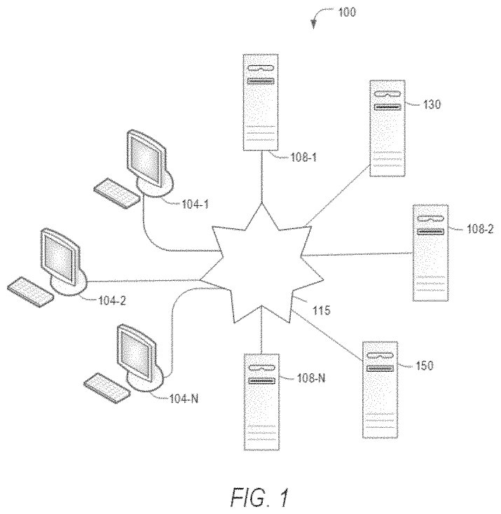

FIG. 1 is a block diagram of an example system 100 for analyzing review content, in accordance with an example embodiment. In one example embodiment, the system 100 may comprise client devices 104-1, . . . 104-N (known collectively as client device 104 hereinafter), servers 108-1, . . . 108-N (known collectively as server 108 hereinafter), and a network 112.

Each client device 104 may be a personal computer (PC), a tablet computer, a mobile phone, a telephone, a personal digital assistant (PDA), a wearable computing device (e.g., a smartwatch), or any other appropriate computer device. In one example embodiment, a user interface module may include a web browser program and/or an application, such as a mobile application. The client device 104 may be used by a user, such as a customer, to conduct a search for a product, service, and the like; to compose and submit a review; and to request and access a review or a review summary or blurb. Although a detailed description is only illustrated for the client device 104, it is noted that other user devices may have corresponding elements with the same functionality.

The network 112 may be a local area network (LAN), a wireless network, a metropolitan area network (MAN), a wide area network (WAN), a wireless network, a network of interconnected networks, the public switched telephone network (PSTN), an electrical power-based network (such as the X. 10 protocol), and the like. Communication links include, but are not limited to, WiFi (e.g., IEEE 802.11), Bluetooth, Universal Serial Bus (USB), and the like. In one example embodiment, the network 112 may comprise one or more routers or device switches.

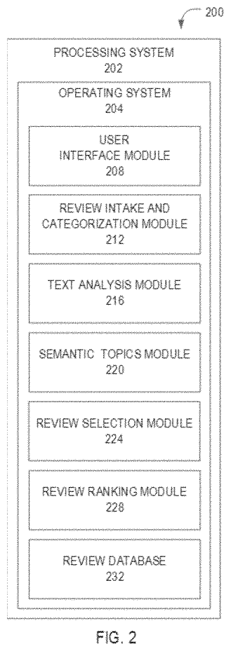

FIG. 2 is a block diagram of an example apparatus 200 for analyzing review content, in accordance with an example embodiment. The apparatus 200 is shown to include a processing system 202 that may be implemented on a server, client, or other processing device that includes an operating system 204 for executing software instructions. In accordance with an example embodiment, the processing system 202 may include a user interface module 208, a review intake and categorization module 212 (known also as review intake module 212 herein), a text analysis module 216, a semantics topic module 220, a review selection module 224, a review ranking module 228, and a review database 232. In one example embodiment, the apparatus 200 may implement the client device 104 or the server 108.

The user interface module 208 provides an interface for conducting a search for a product, service, and the like; for conducting a search for a review; and requesting and accessing a review summary. In one example embodiment, the user interface module 208 also provides an interface for composing and submitting a review to the review database 232. A user may enter a description of or keywords associated with a product or service via the interface and a summary of associated reviews is presented. The review summary may be obtained from the review ranking module 228. The interface may also display an identification of one or more reviews obtained in response to a query; and an identified review may be selected by the user in order to display the selected review via the interface. The interface may also display a blurb in association with an item.

The review intake and categorization module 212 obtains reviews for categorization and storage in the review database 232. The reviews may be obtained, for example, in response to a search for a product or service (or a search for a product or service review) that is submitted by a user via the user interface module 208. In one example embodiment, the reviews in the review database 232 are categorized by topic(s), ranked by a review helpfulness measure, and the like. The review helpfulness measure may be provided by readers of the review, by an analysis of the review, and the like.

The text analysis module 216 analyzes a review to determine sentence quality, sentence sentiment, review helpfulness, and the like. The topic(s) and semantic structures of a sentence or review may be determined using machine learning and natural language processing, as described more fully below; the topic may be defined by a cluster of words that capture the topic. The review helpfulness may be based on the determined sentence quality, sentence sentiment, topic of the sentence or review, and the like.

The semantics topic module 220 determines a unique set of semantic topics for each product or service associated with a review. The semantics topic module 220 may also determine a unique set of semantic topics for each review, for a particular sentence(s) of the review, or both and determines a probability that a selected review matches a given topic. The semantic topics for each item may also be aspects of the item. Aspects are attributes or features of an item discussed in reviews upon which the reviewer expresses an opinion. Aspects may also be opinion targets. In one embodiment, the semantic topic module 220 may identify aspects of the item by identifying aspect candidates in the reviews that express opinions on attributes of the item or features of the item, and aggregating the aspect candidates and associated opinions to quantify importance of the aspect candidates as collectively expressed by the reviews. In one embodiment, to quantify importance of the aspect candidates, the semantic topic module 220 may determine frequency of occurrence of each of the aspect candidates and/or determine aggregate sentiments associated with each of the aspect candidates. In one embodiment, the semantic topic module 220 may use a dependency tree to identify dependencies that capture the relations between the aspects and the words associated with the aspects. Taking for example a camera as an item, the aspects of the camera may include: shutter speed, aperture, and zoom range.

The review selection module 224 selects a set of reviews based on the probability that a review is helpful (as determined by the text analysis module 216, the review intake module 212, or both) and based on a probability that a review represents a particular topic (as determined by the semantics topic module 220). For example, the probability that a review is helpful can be multiplied by the probability that a review represents a given topic and the result may be used to rank and select reviews for summarization. The review selection module 224 may also identify sentences including occurrences of the aspects of the item. In one embodiment, the review selection module 224 includes an excerpt extraction module (not shown) that extracts excerpts from the sentences that are coherent, shorter than a predetermined length, and capture at least one of the aspects of the item. The excerpt extraction module may utilize a constituency sentence parse tree of each of the sentences to identify coherent excerpts.

The review ranking module 228 ranks, selects, and extracts sentences from the set of reviews based on sentence quality, sentence sentiment, review and sentence helpfulness scores, and the like. The extracted sentences may be compiled into a review summarization. In addition, the extracted sentences may be pruned to accommodate a smaller display of a client device. The review ranking module 228 may also rank the excerpts extracted by the excerpt extraction module. In one embodiment, the ranking of the excerpts is based on at least one of: syntax, grammar, sentiment, rating by a reviewer, overall rating of the item by reviewers, number of positive reviews and number of negative reviews. The review ranking module 228 may also use a gradient boosted tree based classifier to classify the excerpts prior to ranking the excerpts. In one embodiment, the excerpts are classified as being interesting, neutral or not interesting. The excerpts that are classified as interesting are then ranked by the review ranking module 228. In one embodiment, the review ranking module 228 then selects one of the excerpts based on the ranking to be the blurb of the item. For example, the highest ranked excerpt may be selected to be the blurb of the item.

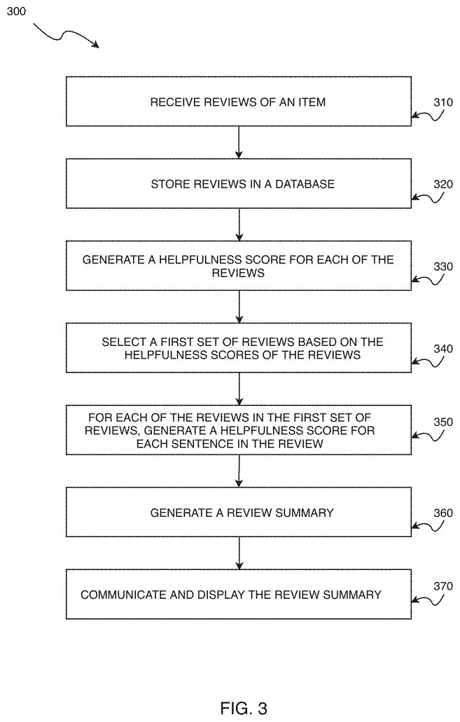

FIG. 3 is a flowchart of a method 300 for analyzing review content, in accordance with an example embodiment. The method 300 starts by receiving a plurality of reviews for an item (e.g., product, service, etc.) at Block 310. The reviews may be submitted by a number of reviewers via the network using a client device. In one embodiment, the reviews for the item may be received in response to an inquiry from a user using a client device. For example, the user may input via the client device an inquiry or search for the item. In response, the user via the client device may receive a plurality of search results for the item as well as a plurality of reviews for the item. In another embodiment, the user may input via the client device an inquiry or search for reviews for the item and in response, the user via the client device may receive the plurality of reviews for the items. In one embodiment, the plurality of reviews for the item that are received at Block 310 may be based on, for example, the user's profile information, search queries, purchase history, etc. In this embodiment, the plurality of reviews for the item that are received at Block 310 may be pre-selected to be more helpful or tailored to the user. At Block 320, the reviews are stored in the review database.

At Block 330, a helpfulness score for each review is generated. The machine learning system may determine a review helpfulness score based, for example, on feedback obtained from a user(s) of the review. The user(s) of the review may be a plurality of users that have viewed the review on their client devices and have provided feedback on the review. For example, a user may mark a review as helpful or not helpful, or may mark a review based on a helpfulness scale (for instance, on a scale of zero to ten). The feedback may be obtained in response to the presentation of the review to the user. Feedback from multiple users may be used to produce a cumulative helpfulness score. For example, the feedback for a review from multiple users may be averaged to produce the cumulative helpfulness score.

At Block 340, a first set of reviews from the plurality of reviews received is selected based on the helpfulness score of each review that was generated in Block 330.

At Block 350, a helpfulness score for each sentence in each review in the first set of reviews is generated. The sentence helpfulness score may be based on the quality of the composition of the sentence, the topic(s) of the sentence, the sentiment of the sentence, etc. For example, a sentence written with proper grammar and that addresses a topic of relevance (such as a description of a product feature that is frequently requested by a user) may be used to generate the sentence helpfulness score. In one embodiment, the reviews are stored in the review database and may be categorized in the review database based on the sentence helpfulness score, the review helpfulness score, the cumulative helpfulness score, or any combination thereof.

At Block 360, a review summary is generated. During generation of the reviews, a semantic topic(s) of the review, a semantic topic(s) of each sentence of the review, or both may be determined. The topic(s) and semantic structures of the review may be determined using machine learning and natural language processing; the topic may be defined by a cluster of words that capture the topic. The semantic topic(s) may be used to identify the latent structure of the review. For example, for a mobile device, topics such as a description of a screen, a user interface, a battery, a noise, and the like may be identified in different reviews.

In one example embodiment, a topic model (also known as a statistical model or a probabilistic topic model) is used to determine the topic of the review based, for example, on the frequency of occurrence of different words in the review. For example, the frequency of occurrence of the words “lens,” “battery,” “microphone,” and “speaker” may vary based on whether the review is for a camera or a smart phone that includes a camera. Moreover, the relative frequency of the cited words may indicate whether the review for a smartphone is primarily about the features of the camera of the smart phone or primarily about the features of the telephonic capabilities of the smart phone. The review may also be subjected to natural language processing to produce artifacts, such as n-grams, review phrases, and the like.

In one example embodiment, the review summary is generated from sentences of the reviews related to a particular semantic topic(s). For example, for a camera product, one sentence of the review may discuss the compact size of the camera and another sentence may mention the advantage of being easy to use, the picture quality, or both. Each sentence may have positive sentiment, negative sentiment, or both. The review summary may be a compilation of sentences that cover a variety of semantic topics and may indicate the source of the sentence (such as the identity of the review associated with the sentence), the identity of the author of the sentence, etc.

In one example embodiment, a sentiment for each of one or more sentences of the review is determined. The sentiment of each sentence of the review may be determined using text analysis and natural language processing. The sentiment may gauge the reviewer's evaluation or judgment of the reviewed item or service. For example, the sentiment may indicate whether the sentence of the review is positive, negative, or neutral in sentiment, or may indicate the sentiment on a scale of, for example, −1 to +1 (where a negative value indicates negative sentiment and a positive value indicates positive sentiment).

In one example embodiment, a sentence is classified according to sentiment based on the presence of particular affect words, such as effective, excellent, and reliable (knowledge-based classification). Statistical methods, such as bag of words and latent semantic analysis, may also be used. The bag of words technique is, for example, relatively simple to implement, but disregards sentence elements, such as word order and context.

In one embodiment, the review helpfulness score may be used to initially filter the reviews. In addition, the review helpfulness score may be used to select the most helpful reviews for the review summary. The review may be evaluated on a sentence by sentence basis and the sentence helpfulness scores may be used to select sentences for the review summary. The sentences may be ranked based on, for example, knowledge of the source of the review, sentence quality, sentence topic, etc. For example, the sentences of a review from a user who frequently submits feedback on the reviews may be assigned a higher sentence helpfulness score than sentences of a review from a user who infrequently submits feedback on the reviews.

In one example embodiment, the sentences selected for the review summary may be pruned or shortened based on the amount of available display space, based on whether the content of the sentence is covered by other sentences, etc. For example, the sentences may be categorized by topic and the sentences with the lowest helpfulness scores for each category may be pruned from the review summary. In one example embodiment, sentences are selected to ensure that all topics covered by the reviews are covered by the review summary.

At Block 370, the review summary is communicated to a client device to be displayed on the client device to the user. For example, the review summary may be displayed above a set of one or more reviews, on a webpage displaying products or services for sale, etc.

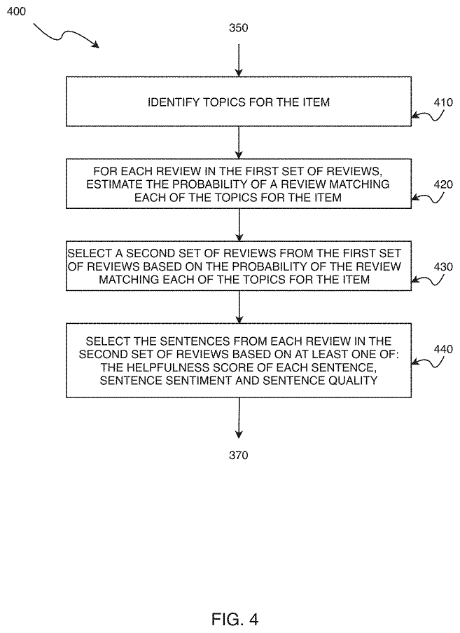

FIG. 4 is a flowchart for an example method 400 of generating a review summary from Block 360 in method 300 in accordance with one embodiment. In one example embodiment, one or more of the operations of the method 400 may be performed by the review intake module 212, the text analysis module 216, the semantics topic module 220, the review selection module 224, the review ranking module 228, or any combination thereof.

To generate the review summary, method 400 starts identifying a plurality of topics for the item at Block 410. A topic model is used to identify a unique set of semantic topics for each product and service associated with a selected review. A semantic topic(s) of the review, a semantic topic(s) of each sentence of the review, or both may also be determined.

At Block 420, for each review in the first set of reviews, a probability of the review matching each of the plurality of topics for the item, respectively, is determined.

At Block 430, a second set of reviews is selected from the first set of reviews based on the probability of the review matching each of the plurality of topics for the item. The probability of each review matching a given topic may be estimated. The probability may be based on, for example, statistical means where a vector space model is used to correlate terms between the review and the given semantic topic.

At Block 440, selecting sentences from each review in the second set of reviews based on at least one of: the helpfulness score of each sentence, sentence sentiment, and sentence quality. In this embodiment, the review summary includes the selected sentences from each review in the second set of reviews.

In one embodiment, selecting the sentences includes ranking the sentences from each review in the second set of reviews by helpfulness for each topic in the plurality of topics for the item; and selecting one or more sentences with the highest helpfulness score for each topic. In one embodiment, the selection of the reviews may be based on, for example, a review helpfulness score submitted by a reader of the review, the sentence helpfulness score(s), a cumulative helpfulness score, or any combination thereof.

A sentiment for each of one or more sentences of the review is determined. The sentiment of each sentence of the review may be determined using text analysis and natural language processing and may gauge the reviewer's evaluation or judgment of the reviewed item.

In one example embodiment, a set of reviews is formed as an extraction pool based on a probability that a review is helpful and the probability that a review represents a given topic. For example, the probability that a review is helpful can be multiplied by the probability that a review represents a given topic and the reviews can then be ranked based on the results, where the reviews having the largest ratings can be assigned to the extraction pool.

A ranking algorithm is applied to the set of reviews to extract sentences from the extraction pool based on sentence quality, sentence sentiment, and the helpfulness scores. For example, the sentences may be ranked based on the value of each sentence helpfulness score.

In one example embodiment, the review summary is generated based on the extracted sentences. For example, the extracted sentences may be compiled into a single set of sentences.

The sentences selected for the review summary may also be pruned based on the amount of available display space, based on whether the information is repetitive, and the like. For example, if the display space allows up to 800 characters, then the complete sentences contained in the first 800 characters of the review summary may be maintained in the review summary and the other sentences may be pruned from the review summary. In one example embodiment, individual sentences may be pruned in length to create phrases in order to reduce the character count of the review summary.

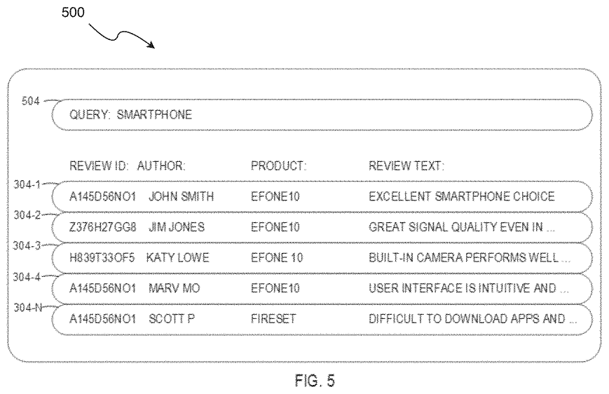

FIG. 5 illustrates an example user interface 500 displaying reviews for a type of item, in accordance with an example embodiment. A query field 504 may be used to enter a query for a review. The query may be a text-based query for, for example, a smartphone product. In this example, the type of item is a smartphone. One or more reviews 304-1, . . . 304-N may be identified via the user interface 500 and may include a review identifier, a review author, a review product/service description, and a portion of the review text. In one example embodiment, the user interface 500 is generated by the user interface module 208, the client device 104, or a combination thereof.

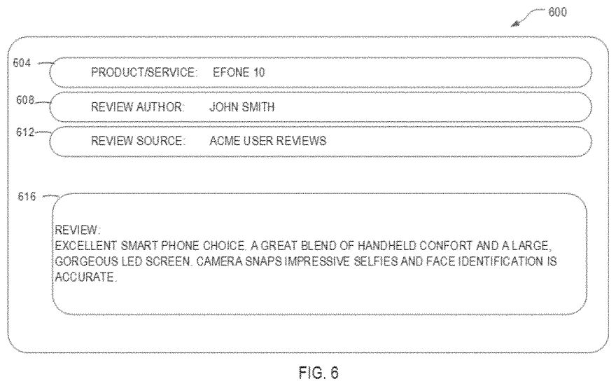

FIG. 6 illustrates an example user interface 600 displaying a review for one of the items, in accordance with an example embodiment. The user interface 600 may be displayed in response to the selection of a review 304-1 from the user interface 500. The user interface 600 comprises a product/service identification field 604, a review author field 608, a review source field 612, and a review text field 616. In one example embodiment, the user interface 600 is generated by the user interface module 208, the client device 104, or a combination thereof.

The product/service identification field 604 identifies the product or service under review. The review author field 608 identifies the author of the review. The review source field 612 identifies the data source from which the review was obtained, such as a website or database that provided the review 304. The review text field 616 displays the text, or a portion of the text, contained in the review 304.

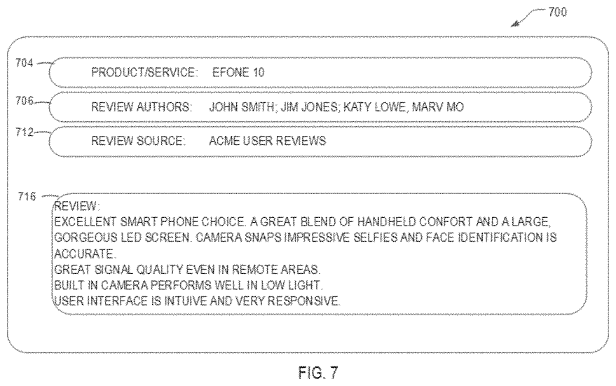

FIG. 7 illustrates an example user interface 700 displaying the review summary of one of the items, in accordance with an example embodiment. The user interface 700 comprises a product/service identification field 704, a review author field 708, a review source field 712, and a review summary text field 716. In one example embodiment, the user interface 700 is generated by the user interface module 208, the client device 104, or a combination thereof. The review summary may include complete sentences, sentence fragments (phrases), or both.

The product/service identification field 704 identifies the product or service under review. The review author field 708 identifies the author(s) of the review(s) 304 used to compile the review summary. The review source field 712 identifies the data source(s) from which the review(s) 304 was obtained, such as a website or database that provided the review(s) 304. The review summary text field 716 displays the text, or a portion of the text, contained in the review summary. As shown in the review summary text field, the sentences that are selected from each review of that item (e.g., the reviews of EFONE 10 in FIG. 5) are analyzed and ranked to generate a summary review. As shown in FIG. 7, the sentences that are highest ranked may be displayed in the review summary text field. While not shown, the identification of the reviewers (e.g., reviewer's name or online handle) associated with the displayed sentences may also be displayed in the review summary text field to provide credibility to each of the sentences in the review.

As shown in the FIG. 3-7, embodiments of the present invention generate an improved user interface that provides a review summary to efficiently consume reviews of an item by providing the user with streamlined access to the most helpful review sentences that may be buried in a potentially large number of individual reviews. Rather than searching for an item and navigating through each of the individual reviews displayed on the user interface as separate line items (FIG. 5) to be selected and opened to a single page (FIG. 6) to obtain various information or opinions on the item, the user may access the review summary directly on a single page of the user interface (FIG. 7).

Although certain examples are shown and described here, other variations exist and are within the scope of the invention. It will be appreciated, by those of ordinary skill in the art, that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

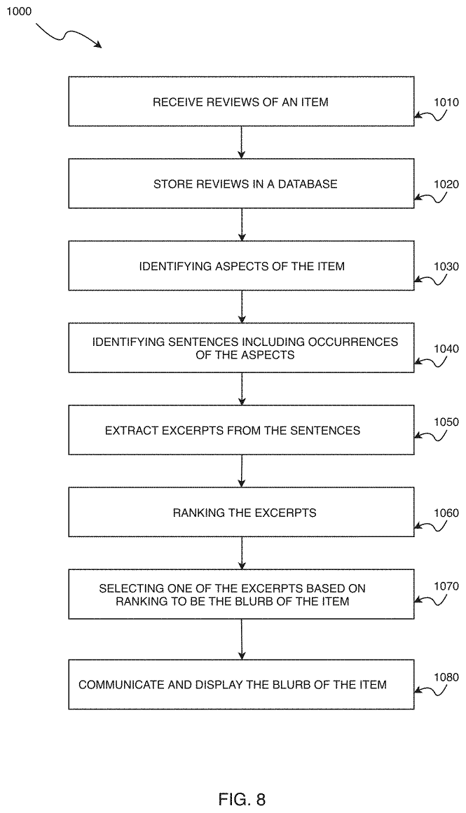

FIG. 8 is a flowchart of an example method 1000 for analyzing review content to generate a blurb, in accordance with one embodiment. Similar to method 300, the method 1000 starts by receiving a plurality of reviews of an item (Block 1010) and storing the reviews of the item in a review database (Block 1020).

At Block 1030, aspects of the item are identified. Aspects are attributes or features of an item discussed in reviews upon which the reviewer expresses an opinion. Aspects may also be opinion targets. Taking for example a camera as an item, the aspects of the camera may include: shutter speed, aperture, and zoom range. In one embodiment, identifying aspects of the item includes identifying aspect candidates in the reviews that express opinions on attributes of the item or features of the item, and aggregating the aspect candidates and associated opinions to quantify importance of the aspect candidates as collectively expressed by the reviews. In one embodiment, to aggregate the aspect candidates and associated opinions, the frequency of occurrence of each of the aspect candidates and/or aggregate sentiments associated with each of the aspect candidates may be determined and analyzed. These provide measures of importance of the aspect and the opinions. In one embodiment, a dependency tree may be used to identify dependencies that capture the relations between the aspects and the words associated with the aspects.

In order to be an effective or relevant blurb, a blurb should contain item specific content, while being short in length. Accordingly, at Block 1040, sentences including occurrences of the aspects of the item are identified and at Block 1050, excerpts that are coherent, shorter than a predetermined length, and capture at least one of the aspects of the item are extracted from the sentences. In one embodiment, extracting excerpts includes utilizing a constituency sentence parse tree of each of the sentences to identify coherent excerpts. The constituency parse trees may organize the syntactical structure into constituents based on the observation that words combine with other words to form linguistic structures. A Stanford parser may be used to generate the constituency parse tree for a given sentence. Using the constituency parse tree, a subtree is identified as the extracted except.

At Block 1060, the excerpts are ranked. A supervised learning model may be used to rank the excerpts by leveraging crowd wisdom to represent the popularity of topics and sentence quality to pick the most interesting, accurate and agreed upon excerpts. The supervised learning model is trained to identify the interesting excerpts using, for example, syntactic, grammatical, sentiment-based and review-based features. Parts of speech tags of words in the original review sentence and excerpt may be used to build features that capture the numbers of adjectives, adverbs, nouns and verbs. Features based on dependency relations between aspect and opinion terms in the excerpt may further provide syntactic information. Text features such as character length, number of words in the sentence and the excerpt, tf-idf scores of the corresponding aspect and its frequency of occurrence among excerpt candidates may also be adopted. To capture the sentiment associated with the review, the positive, negative and compound sentiment of the sentence may be used. Further, the product and review-specific features such as rating provided by the reviewer, overall rating for the product and numbers of positive and negative ratings for the product are used. Accordingly, in one embodiment, the excerpts are ranked based on at least one of: syntax, grammar, sentiment, rating by a reviewer, overall rating of the item by reviewers, number of positive reviews and number of negative reviews.

In one embodiment, a gradient boosted tree based classifier may also be used to classify the excerpts prior to ranking the excerpts. Features related to aspect-pertinent metrics within the reviews, and those that quantify sentiment may assist the classifier in learning excerpts that are interesting. In one embodiment, the excerpts are classified as being interesting, neutral or not interesting. The excerpts that are classified as interesting are then ranked.

At Blocked 1070, one of the excerpts is selected based on the ranking to be the blurb of the item. In one embodiment, the highest ranked excerpt may be selected to be the blurb of the item.

At Block 1080, the blurb of the item in association with the item is communicated to an electronic device and caused to be displayed on a display of the electronic device to the user.

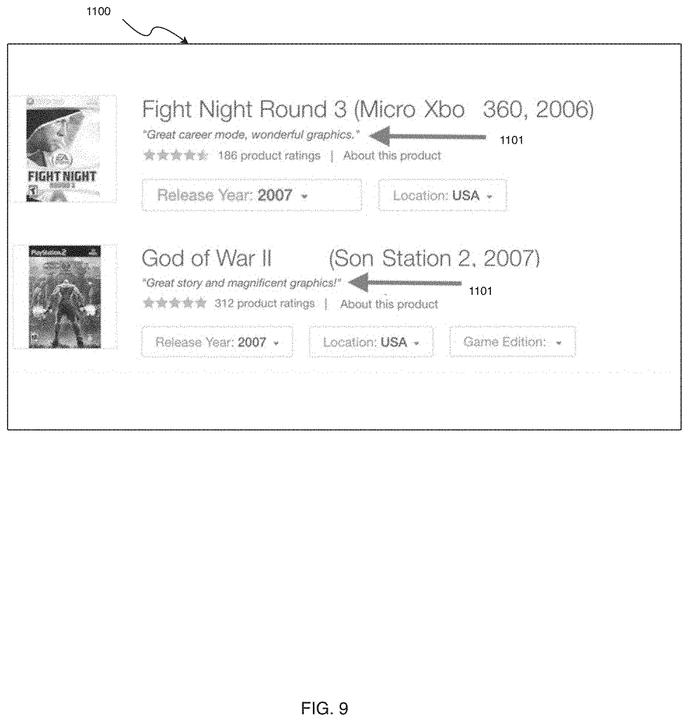

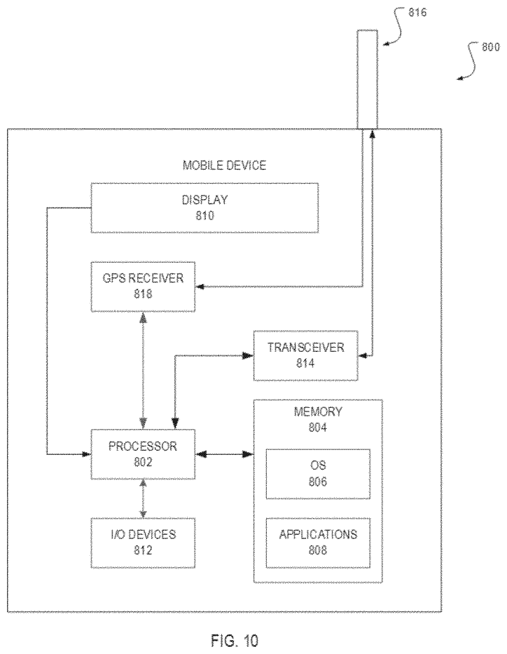

FIG. 9 illustrates an example user interface 1100 displaying the blurbs associated with the items, in accordance with an example embodiment. The user interface 1100 may be displayed in response to a query for a type of item (e.g., video games). As shown in user interface 1100, a list of items of that type of item is displayed. Each of the items in the list of items may include, for example, the title of the item (e.g., name of the video game), an image of the cover art associated with the item (e.g., cover art of the video game), the price of the item, a star rating of the item, and a brief description. The blurbs 1101 generated using method 800 of FIG. 8 may be displayed with each of the items, respectively. For example, the item “Fight Night Round 3” is displayed with the blurb 1101 “Great career mode, wonderful graphics.” Rather than in response to a query, the user interface 1100 may also be displayed unprompted by a user. For example, the user interface 1100 may also be displayed as an advertisement content, as the top rated items, or as the best selling items.

As shown in FIG. 8-9, embodiments of the present invention generate an improved user interface that includes blurbs generated from reviews in association with an item. Given that the blurbs are generated using reviews rather than using the manufacturer or seller's comments or taglines, the blurbs add a factor of trust and engagement. The blurbs are also tailored to be based on the identified aspects of the item and the sentences in reviews that include the identified aspects. As above, rather than searching for an item and navigating through each of the individual reviews displayed on the user interface as separate line items (FIG. 5) to be selected and opened to a single page (FIG. 6) to obtain various information or opinions on the item, the user may access the improved user interface 1100 (FIG. 9) are view the blurb displayed in association with the item.

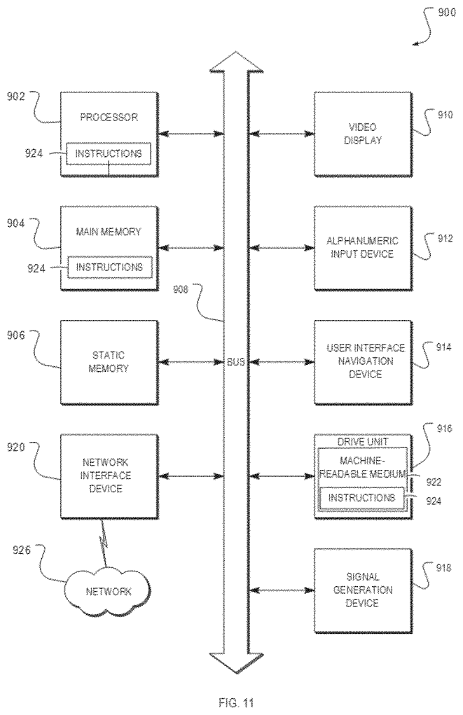

FIG. 10 is a block diagram illustrating an example mobile device 800, according to an example embodiment. The mobile device 800 may include a processor 802. The processor 802 may be any of a variety of different types of commercially available processors suitable for mobile devices (e.g., an XScale architecture microprocessor, a microprocessor without interlocked pipeline stages (MIPS) architecture processor, or another type of processor 802). A memory 804, such as a random access memory (RAM), a flash memory, or another type of memory, is typically accessible to the processor 802. The memory 804 may be adapted to store an operating system (OS) 806, as well as application programs 808, such as a mobile location-enabled application that may provide location-based services (LBSs) to a user. The processor 802 may be coupled, either directly or via appropriate intermediary hardware, to a display 810 and to one or more input/output (I/O) devices 812, such as a keypad, a touch panel sensor, a microphone, and the like. Similarly, in some embodiments, the processor 802 may be coupled to a transceiver 814 that interfaces with an antenna 816. The transceiver 814 may be configured to both transmit and receive cellular network signals, wireless data signals, or other types of signals via the antenna 816, depending on the nature of the mobile device 800. Further, in some configurations, a Global Positioning System (GPS) receiver 818 may also make use of the antenna 816 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

FIG. 11 is a block diagram of a machine in the example form of a computer system 900 within which instructions may be executed for causing the machine to perform any one or more of the methodologies discussed herein. In one example embodiment, the machine may be the example apparatus 200 of FIG. 2 for analyzing review content. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a PDA, a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker), and a network interface device 920.

The drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media 922. The instructions 924 may also reside within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more data structures or instructions 924. The term “machine-readable medium” shall also be taken to include any tangible medium that is capable of storing, encoding, or carrying the instructions 924 for execution by the machine and that cause the machine to perform any one or more of the methodologies of the present invention, or that is capable of storing, encoding, or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks, magneto-optical disks; and Compact Disk-Read-only Memory (CD-ROM) and Digital Versatile Disc-Read-only Memory (DVD-ROM) disks.

A “machine-readable medium” may refer to a single storage apparatus or device, as well as cloud-based storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. In some embodiments, a “machine-readable medium” may also be referred to as a “machine-readable storage device.”

Furthermore, the machine-readable medium 922 is non-transitory in that it does not embody a propagating or transitory signal. However, labeling the machine-readable medium 922 as “non-transitory” should not be construed to mean that the medium is incapable of movement—the medium should be considered as being transportable from one physical location to another. Additionally, since the machine-readable medium 922 is tangible, the medium may be considered to be a machine-readable storage device.

The instructions 924 may further be transmitted or received over a communications network 926 using a transmission medium. The instructions 924 may be transmitted using the network interface device 920 and any one of a number of well-known transfer protocols (e.g., hypertext transfer protocol (HTTP)). Examples of a communications network 926 include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying the instructions 924 for execution by the machine, and includes digital or analog communications signals or other intangible media to facilitate communication of such instructions 924.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for analyzing review content to generate a review summary, the apparatus comprising:
one or more hardware processors;
memory to store instructions that, when executed by the one or more hardware processors, cause the one or more hardware processors to perform operations comprising:
receiving a plurality of reviews for an item;
generating a helpfulness score for each review in the plurality of reviews;
selecting a first set of reviews based on the helpfulness scores for each review in the plurality of review;
generating a helpfulness score for each sentence in each review in the first set of reviews;
generating a review summary, wherein generating the review summary includes:
selecting sentences in each review in the first set of reviews based on the helpfulness score of each sentence, wherein the review summary includes the selected sentences; and
displaying the review summary in association with the item on a display of an electronic device.

2. The apparatus of claim 1, wherein generating the review summary includes:
identifying a plurality of topics for the item;
for each review in the first set of reviews, determine a probability of the review matching each of the plurality of topics for the item;
selecting a second set of reviews from the first set of reviews based on the probability of the review matching each of the plurality of topics for the item; and
selecting sentences from each review in the second set of reviews based on the helpfulness score of each sentence, wherein the review summary includes the selected sentences from each review in the second set of reviews.

3. The apparatus of claim 2, wherein identifying the plurality of topics for the item includes using a topic model to identify a unique set of semantic topics for the item.

4. The apparatus of claim 3, wherein determining the probability of the review matching each of the plurality of topics for the item is based on a vector space model used to correlate terms.

5. The apparatus of claim 3, wherein selecting the sentences from each review in the second set of reviews includes ensuring that the review summary covers each topic of the unique set of the semantic topics for the item.

6. The apparatus of claim 5, wherein selecting the sentences from each review in the second set of reviews includes:
ranking the sentences from each review in the second set of reviews by helpfulness for each topic in the plurality of topics for the item; and
selecting one or more sentences with the highest helpfulness score for each topic.

7. The apparatus of claim 1, the operations further comprising:
for each review in the second set of reviews, determine the sentiment of each sentence in the review; and
selecting sentences from each review in the second set of reviews based on the helpfulness score of each sentence and the sentiment of each sentence.

8. The apparatus of claim 7, wherein selecting sentences from each review in the second set of reviews based on the helpfulness score of each sentence, the sentiment of each sentence and a quality of a composition of a sentence.

9. The apparatus of claim 1, wherein generating the helpfulness score for each review in the plurality of reviews includes obtaining a helpfulness score from one or more readers of the review.

10. The apparatus of claim 1, wherein generating the helpfulness score for each review in the plurality of reviews is based on a cumulative helpfulness score of two or more reviews.

11. The apparatus of claim 1, wherein generating the helpfulness score for each review in the plurality of reviews is based on the helpfulness scores for each sentence in each review.

12. The apparatus of claim 1, wherein generating the review summary includes removing one or more selected sentences from each review based on an amount of available display space.

13. The apparatus of claim 1, wherein selecting sentences from each review is based on knowledge of a source of the review.

14. A method for analyzing review content to generate a review summary, the method comprising:
receiving a plurality of reviews for an item;
generating a helpfulness score for each review in the plurality of reviews;
selecting a first set of reviews based on the helpfulness scores for each review in the plurality of review;
generating a helpfulness score for each sentence in each review in the first set of reviews;
generating a review summary, wherein generating the review summary includes:
selecting sentences in each review in the first set of reviews based on the helpfulness score of each sentence, wherein the review summary includes the selected sentences; and
displaying the review summary in association with the item on a display of an electronic device.

15. The method of claim 14, wherein generating the review summary includes:
identifying a plurality of topics for the item;
for each review in the first set of reviews, determine a probability of the review matching each of the plurality of topics for the item;
selecting a second set of reviews from the first set of reviews based on the probability of the review matching each of the plurality of topics for the item; and
selecting sentences from each review in the second set of reviews based on the helpfulness score of each sentence, wherein the review summary includes the selected sentences from each review in the second set of reviews.

16. The method of claim 14, the operations further comprising:
for each review in the second set of reviews, determine the sentiment of each sentence in the review; and
selecting sentences from each review in the second set of reviews based on the helpfulness score of each sentence and the sentiment of each sentence.

17. The method of claim 16, wherein selecting sentences from each review in the second set of reviews based on the helpfulness score of each sentence, the sentiment of each sentence and a quality of a composition of a sentence.

18. The method of claim 14, wherein generating the review summary includes removing one or more selected sentences from each review based on an amount of available display space.

19. The method of claim 14, wherein selecting sentences from each review is based on knowledge of a source of the review.

20. A non-transitory computer-readable medium embodying instructions that, when executed by a processor, causes the processor perform a method of analyzing review content to generate a review summary, the method comprising:
receiving a plurality of reviews;
generating a helpfulness score for each review in the plurality of reviews;
selecting a first set of reviews based on the helpfulness scores for each review in the plurality of review;
generating a helpfulness score for each sentence in each review in the first set of reviews;
generating a review summary, wherein generating the review summary includes:
selecting sentences in each review in the first set of reviews based on the helpfulness score of each sentence, wherein the review summary includes the selected sentences; and
displaying the review summary in association with the item on a display of an electronic device.

21. A method for analyzing review content to generate a blurb, the method comprising:
receiving a plurality of reviews for an item;
identifying a plurality of aspects of the item;
identifying a plurality of sentences including occurrences of the plurality of aspects of the item;
extracting a plurality of excerpts from the plurality of sentences that are coherent, shorter than a predetermined length, and capture at least one of the plurality of aspects of the item;
ranking the plurality of excerpts;
selecting one of the excerpts based on the ranking to be the blurb of the item; and
displaying the blurb of the item in association with the item on a display of an electronic device.

22. The method of claim 21, wherein identifying the plurality of aspects of the item includes:
identifying aspect candidates in the reviews that express opinions on attributes of the item or features of the item; and
aggregating the aspect candidates and associated opinions to quantify importance of the aspect candidates as collectively expressed by the reviews.

23. The method of claim 22, wherein identifying the plurality of aspects of the item further includes:
using a dependency tree to identify dependencies that capture the relations between the aspects and the words associated with the aspects.

24. The method of claim 23, wherein aggregating the aspect candidates and associated opinions to quantify importance of the aspect candidates as collectively expressed by the reviews includes at least one of:
determining frequency of occurrence of each of the aspect candidates, respectively, or
determining aggregate sentiments associated with each of the aspect candidates.

25. The method of claim 21, wherein extracting a plurality of excerpts from the plurality of sentences includes:
utilizing a constituency sentence parse tree of each of the sentences to identify coherent excerpts.

26. The method of claim 21, wherein ranking the plurality of excerpts includes ranking the plurality of excerpts based on at least one of: syntax, grammar, sentiment, rating by a reviewer, overall rating of the item by reviewers, number of positive reviews and number of negative reviews.

27. The method of claim 26, wherein ranking the plurality of excerpts further includes:
using a gradient boosted tree based classifier to classify the excerpts.
